(19) United States
(12) Patent Application Publication
(10) Pub. No.: US 2012/0111792 A1
(43) Pub. Date: May 10, 2012

(54) APPARATUS FOR AUTOMATICALLY ADSORBING AND RECYCLING FLOATING OIL ON WATER

(75) Inventor: Jianmei Lu, Suzhou (CN)

(73) Assignee: Suzhou Timelyblue Environmental Technology Co., Ltd., Suzhou (CN)

(21) Appl. No.: 13/163,576

(22) Filed: Jun. 17, 2011

(30) Foreign Application Priority Data
Nov. 5, 2010 (CN) 201010532952.X

(51) Int. Cl. B01D 15/02

(52) U.S. Cl. 210/502.1

(57) ABSTRACT

The invention relates to oily water treatment equipment, specifically relates to an apparatus for automatically adsorbing and recycling floating oil on water, which includes: base, stand, drive unit, transmission unit, compression unit, the conveyor belt and the oil-absorbing resin set on the surface of the conveyor belt; wherein, the drive unit drives the conveyor belt to rotate via said transmission unit; said compression unit includes at least one pair of squeeze rollers, and said conveyor belt, squeezed by said pair of squeeze rollers, goes across said pair of squeeze rollers; the fore-end of said conveyor belt is under the horizontal level of said base; said compression unit is set in the downstream side of the highest position of the conveyor belt; a tension roller is set between the fore-end and back-end of the conveyor belt, and said tension roller is set above the horizontal level of back-end of the conveyor belt.

### CROSS-REFERENCES TO RELATED APPLICATIONS

This application claims priority from Chinese Patent Application Number 201010532952.X, filed on Nov. 5, 2010, the contents of which are fully incorporated herein by reference in its entirety.

### FIELD OF THE INVENTION

This invention relates generally to an apparatus for extracting oil from water, and more particularly to an apparatus for automatically adsorbing and recycling floating oil on water.

### BACKGROUND

In recent years, there has been a number of incidents involving the accidental spillage of crude oil, refined oil and toxic organic chemicals into the oceans and other bodies of water. Statistics suggest that over 1,400 these accidents happened in the past 3 years in China alone. However, there is insufficient research on the technology and equipments to deal with such accidents, because these accidents happened randomly, which makes both the government and related parties in these accidents helpless. At present, damage control usually relies on oil absorption material, such as straw, cotton or polymer blankets, to adsorb the floating oil. These solutions require a lot of work but the efficiency is low, and these solutions do not allow for the recycling of the spilled contaminants. Other solutions involve dusting or spraying a large amount of dispersants to disperse spilled oil into water, but this brings with it the risk of harming the environment. Meanwhile, it takes hundreds of years for the degradation of these dispersants and the leakage in the water, so that will cause death and sickness of local aquatic plants and animals.

As oil spill accidents can happen at any place at any time, they are difficult to protect against, and if they are not addressed in a timely manner, they will cause varying degrees of pollution diffusion. At present, oily water is treated with biological or chemical progress, which requires huge and heavy treatment machines, and it also takes some time to adjust these machines to work, so these treatment machines can not deal with spills very well.

For example, to deal with sudden water pollution accidents effectively, a Chinese patent of Utility Model (Patent No. 20082000153.1) discloses an emergency treatment device, which comprises water collecting part, water treatment part and support part; wherein water collecting part includes water pump trailer and material trailer, and a sewage pump, controlled by a electrical control cabinet, is installed inside the water pump trailer, the water inlet of the sewage pump links with a rubber pipe, and the outlet is linked to water treatment part; material trailer is equipped with rubber pipes, metal boxes, the bottom valve, floats, anchors and anchor chains, float and inflatable boats. The water treatment part includes water treatment equipment trailer, monitoring device trailer and regeneration device trailer, wherein water treatment equipment, filled with activated charcoal, linked to water outlet of aforesaid the water inlet of the sewage pump, is installed in water treatment equipment trailer; water was carried out through the outlet of water treatment equipment after treatment. Inside the monitoring device trailer, a diesel generator trailer, power output counters, water control cabinets, water quality testing equipment are installed. Inside the regeneration system trailers, regeneration device, mailboxes, and device control cabinet, power input cabinet are installed. Support part is comprised by a tank trailer, a catering trailer, a sleeper trailer.

The aforesaid emergency treatment device is still too complicated. Thus, compactly and convenient oil water treatment devices that can adsorb and recycle floating oil on water are needed.

### SUMMARY OF THE INVENTION

The object of the present invention is to provide a compact and convenient oil in water treatment equipment that can adsorb and recycle floating oil on water automatically.

This object is achieved according to the technical scheme of this invention described below, an apparatus for automatically adsorbing and recycling oil on water, which comprises: a base, a stand, a drive unit, a transmission unit, a compression unit, a conveyor belt and oil-absorbing resins set on the surface of the conveyor belt; wherein, the drive unit drives the conveyor belt to rotate via said transmission unit; said compression unit includes at least one pair of squeeze rollers, and said conveyor belt, squeezed by said pair of squeeze rollers, goes across said pair of squeeze rollers; the fore-end of said conveyor belt is under the horizontal level of said base; said compression unit is set in the downstream side of the highest position of the conveyor belt; a tension roller is set between the fore-end and back-end of the conveyor belt, and said tension roller is set above the horizontal level of back-end of the conveyor belt.

In the preferred technical scheme, said compression unit is set in the back side of the conveyor belt.

In the technical scheme above, how the drive unit, transmission unit, and conveyor belt cooperate to work is an existing technique, for example, the drive unit is a motor, the transmission unit includes a drive roller, a tension roller, a driven roller, and marching sprocket wheels, and a chain; the power is transmitted among sprocket wheels via the chain; the conveyor belt is set on the transmission unit, when at working state, the sprocket wheel fixed on the drive roller drives the sprocket wheels of tension roller and driven roller to rotate via the chain, then drives the tension roller and driven roller to rotate, as the conveyor belt has been tensioned, the friction force between the conveyor belt and each of drive roller, tension roller and driven roller would drive the conveyor belt turning up.

In the preferred technical scheme, the driven roller is set in the front-end of a transmission frame the roll angle of which can be adjusted, and the back-end of said transmission frame is pin-connected with the stand of the apparatus for automatically adsorbing and recycling oil on water; an angle adjustment mechanism is set in said transmission frame, specifically, a pair of shafts are set on the sides of said transmission frame, and a matching height adjustment track is set on the stand of the apparatus for automatically adsorbing and recycling oil on the water's surface. However, the angle adjusting mechanism of the present invention is not limited to this aforementioned mechanism.

In the technical scheme above, the compression unit may include at least one pair of squeeze rollers, one of which could be the drive roller or the driven roller or the tension roller, and preferably, one of the pair of squeeze rollers is the drive roller, and the gap between the drive roller and the other squeeze roller can be adjusted. Additionally, a transmission mechanism is set between the drive roller and the other squeeze roller, for example, the drive roller and the other squeeze roller are equipped with a pair of matching sprocket wheels or gear wheels.

In the technical scheme above, said oil-absorbing resins could be selected from existing quick oil-absorbing resins, that do not adsorb water but only oil, and oil will not leak without compression; preferably, preparation method of said oil-absorbing resins comprises following steps set forth in pending U.S. patent application Ser. No. 12/858,763 and Chinese priority application 201010161098.0:
(1) Mixing and stirring well monomer A, vinyl monomer, initiator and vesicant to form a copolymerization system, wherein the amount of monomer A is in the range of approximately 10-50 wt %, the amount of vinyl monomer is in the range of approximately 48-88 wt %, the amount of initiator is in the range of approximately 0.01-5 wt %, the amount of vesicant is in the range of approximately 1-5 wt %;
wherein, the said monomer A is selected from one of: Acrylamide, Hydroxyethyl acrylate, Hydroxypropyl acrylate, Tri(ethylene glycol) divinyl ether, functional monomer T-1168, functional monomer TM-200 or Acrylic ester monomer 2-PHA;
wherein, the said vinyl monomer is selected at least one of: α-methylstyrene, Pentaerythritol tetramethyacrylate, Tri(propylene glycol) diacrylate or Diethylene glycol diacrylate,

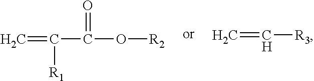

wherein R1 is Methy or Hydrogen, R2 is saturated alkyl of 1 to 18 carbon atoms or naphthyl or phenmethyl, R3 is selected one of: Cyano, Acetate, Phenyl, Pmethylphenyl or Onitrophenyl; and
(2) immersing fiber carriers into the liquid of above-said copolymerization system to adsorb the liquid on the fiber carriers, then heating the fiber carriers under a temperature between 60˜80° C. for 1˜4 hours to synthesize polymers on the fiber carriers.

The aforementioned oil-absorbing resins can not only adsorb oil quickly, but also can hold oil well, that is the adsorption will not leak out from the oil-absorbing resins as a result of the effect of gravity, and the adsorption of oil can be recycled by compressing the oil-absorbing resins. Additionally, the oil-absorbing resins do not adsorb water but only adsorb oily substances, so water-oil separation is not needed.

The afore-said apparatus for automatically adsorbing and recycling oil on water also includes a collecting device, set under the squeeze rollers, used to collect the oily substances squeezed out of oil-absorbing resins.

The apparatus for automatically adsorbing and recycling oil on water can be installed in an ordinary vessel, so it can move on water flexibly and conveniently to absorb and recycle the oil slick.

Due to the application of the above mentioned technical scheme, this invention has the following advantages compared with the existing techniques:

This invention provides an apparatus for automatically adsorbing and recycling oil on water that can adsorb and recycle oily substance continuously; additionally, because this invention applies oil-absorbing resins, which do not adsorb water but only adsorb oily substance, it can recycle the floating oily substance on water, oil-water separation operation is not needed.

This invention provides apparatus for automatically adsorbing and recycling oil on water that can be installed on varying sizes of boats to fulfill different actual needs.

### BRIEF DESCRIPTION OF THE DRAWINGS

FIG. 1 is a perspective view for the apparatus for automatically adsorbing and recycling oil on water of embodiments;

FIG. 2 is a second perspective view for the transmission unit of the apparatus for automatically adsorbing and recycling oil on water of embodiments; and

FIG. 3 is side view of the apparatus of FIGS. 1 and 2.

### DETAILED DESCRIPTION OF THE PREFERRED EMBODIMENTS

This invention will be best understood with reference to the following description of example embodiments.

### Example 1

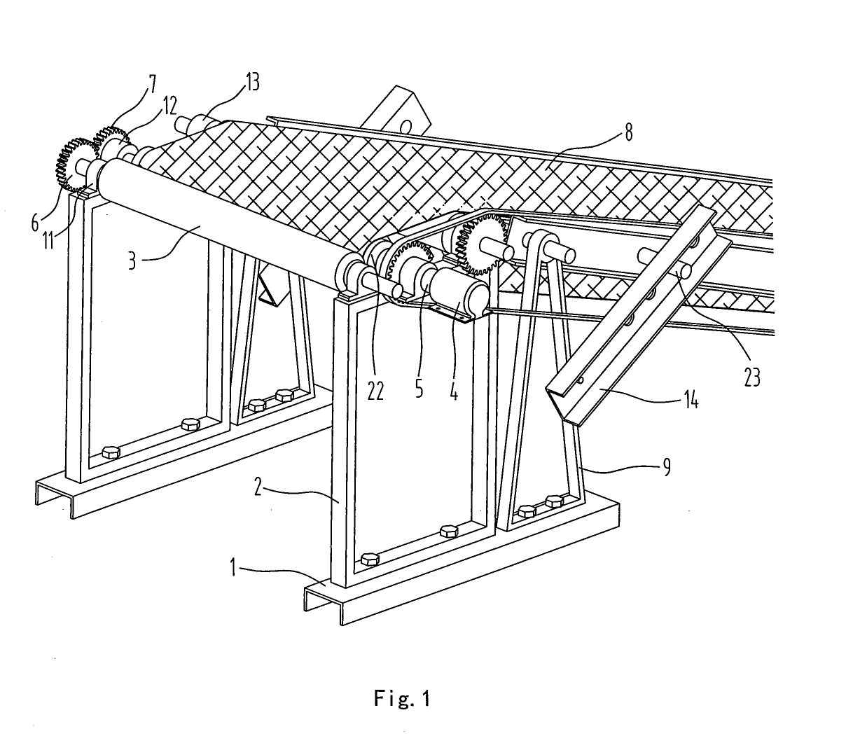

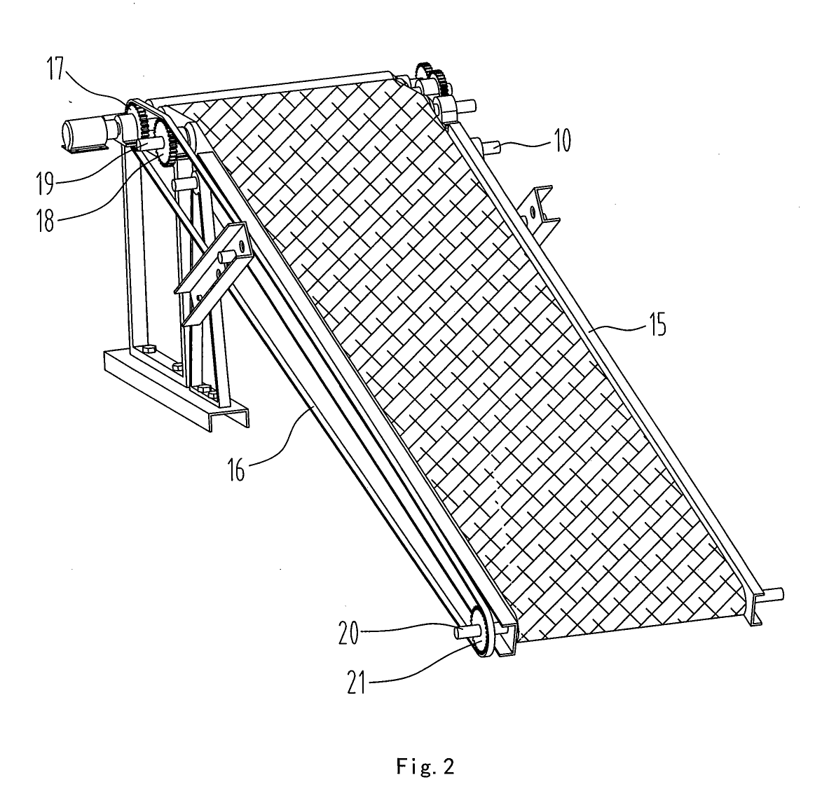

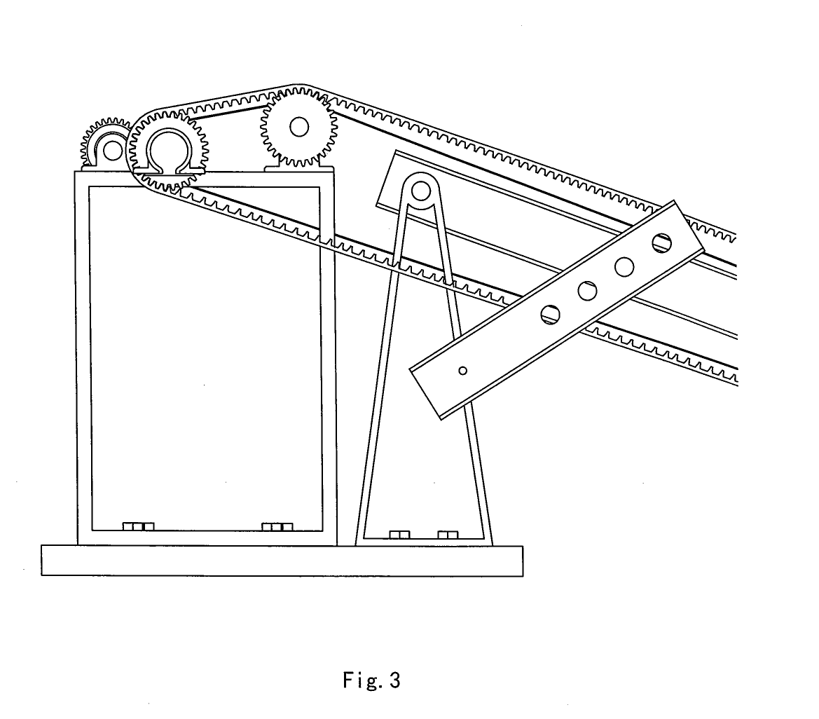

The invention may best be understood with reference to a simple embodiment as described in FIG. 1, FIG. 2 and FIG. 3. An apparatus of the present invention for automatically adsorbing and recycling oil on water comprises: a transmission frame equipped with “sponge-like oil-absorbing resins sheets,” motor 4, drive roller 22, tension roller 19, squeeze roller 3, drive sprocket wheel 7, drive gear wheel 17, sprocket wheel 6, 18 and 21, chain 16, height adjustment track 14, transmission steel mesh 8, base 1, stand 2 and 9.

Base 1 is composed of two heavy channel rails, on which stand 2 is installed. Drive roller 22, tension roller 19, squeeze roller 3 are mounted on stand 2. Motor 4 is fixed on a steel plate which is welded on the top of stand 2. Motor 4 and drive roller 22 are connected through the coupling 5. Drive roller 22 is fixed on top of stand 2 by a pair of fixed holders 12. Squeeze roller 3 is fixed on stand 2 by a pair of holders 11, and the gap between drive roller 22 and squeeze roller 3 can be adjusted by adjusting the holders 11 backward and forward. The sprocket wheel 7 is set on the drive roller 22, and sprocket wheel 6 is set on the drive roller 3, the two sprocket wheels 6 and 7 engage each other to make the squeeze roller 3 rotate by drive roller 22. A tension roller 19 is set on top of stand 2 by a pair of holders 13, and compared with the height of holders 12 in reference to the point where they are set, the height of holders 13 in reference to the point where holders 12 are set is approximately twice as high. A pair of triangle stands 9 are fixed on base 1 and a pair of supporting shafts 10 are fixed in the top vertex angle of both triangle stands. Each of supporting shafts goes through the end of each light steel channels 15, so two light steel channels can't move but can rotate up and down freely. The other ends of the two light steel channels are connected with driven roller 20. Each side of driven roller 20 is equipped with sprocket wheel 21. The transmission steel mesh 8 skirts around the drive roller 22, tension roller 19, supporting shaft 10 and passive roller 20 and form a circle. The tension degree of steel mesh 8 is adjusted by pulling or pushing the holders 13 of tension roller 19 backward and forward. According to the actual situation, the angle between the transmission frame and the horizontal plane can be adjusted by the height adjustment tracks 14. One end of each height adjustment track 14 is fixed on triangle stand 9, and some holes are set on height adjustment track 14, and a matching plug shaft 23 is fixed on light steel channel 15. The angle between the transmission frame and the horizontal plane is determined by plugging shaft 23 into different holes of the light steel channel 15. A chain 16 couples the sprockets wheels 17, 18 and 21.

For the apparatus for automatically adsorbing and recycling oil on water, the drive unit comprises motor 4; the transmission unit includes drive roller 22, tension roller 19, and sprocket wheels 7, 17, 18, 21 and chain 16.

When the apparatus is applied to the oil slick, base 1 is fixed on the head of boat, the end of the transmission frame covered by “sponge-like oil absorb resin sheet” is stretched into water and the driven roller is immersed under water to a depth of over 10 cm. The depth can be adjusted by plugging shaft 23 into different holes of the light steel channel 15.

The “sponge-like oil absorbing resin sheet” is fixed on the steel mesh 8 with a strong cord. The motor 4 is started and the drive roller 22 is driven to rotate through the coupling 5, then the tension roller 19 and passive roller 20 is driven to rotate through the chain 16 which is around the sprocket wheels 18 and 21. At this time, the steel mesh 8 begins to rotate upward acted by the friction force between the steel mesh with the active roller 22, tension roller 19 and passive roller 20. Therefore, the oil absorbing resin sheets start to absorb and transfer the oil slick up. The squeeze roller 4 rotates because the sprocket wheel 6 of it meshes with sprocket wheel 7 of drive roller 22, and the absorbed oil is squeezed out when the oil absorbing resin sheets go through the squeeze roller 4 and drive roller 22. The squeezed oil will overflow the squeeze roller 4 and drop down vertically to a collector which is placed under the squeeze roller 4. This method and apparatus can adsorb and recovery oil slick automatically and continuously. If the transmission frame is designed as 1.5 meter wide and 4 meters long, it can recycle 3 tons oil slick per hour.

I claim:

1. An apparatus for automatically adsorbing and recycling oil on water, comprising:
a base, a stand, a drive unit, a transmission unit, a compression unit, a conveyor belt and oil-absorbing resins set on the surface of the conveyor belt, wherein the drive unit drives the conveyor belt to rotate via said transmission unit;
said compression unit includes at least one pair of squeeze rollers, and said conveyor belt, squeezed by said pair of squeeze rollers, extends across said pair of squeeze rollers;
a first end of said conveyor belt is under a horizontal level of said base;
said compression unit is set in a downstream side of a highest position of the conveyor belt; and
a tension roller set between the first end and a second end of the conveyor belt, and said tension roller is set above a horizontal level of the second end of the conveyor belt.

2. An apparatus for automatically adsorbing and recycling oil on water according to claim 1, wherein said compression unit is set in the second end of the conveyor belt.

3. An apparatus for automatically adsorbing and recycling oil on water according to claim 1, wherein the driven roller is set in the first end of a transmission frame, a roll angle of which can be adjusted, and a second end of said transmission frame is pin-connected with the stand for automatically adsorbing and recycling oil on water; an angle adjustment mechanism is set in said transmission frame.
